(19) United States
(12) Patent Application Publication
(10) Pub. No.: US 2014/0279047 A1
(43) Pub. Date: Sep. 18, 2014

(54) ENHANCING TARGETED ADVERTISING IN A HOME NETWORK GATEWAY DEVICE

(71) Applicant: General Instrument Corporation, Horsham, PA (US)

(72) Inventors: Yeqing Wang, Horsham, PA (US); Christopher S. DelSordo, Souderton, PA (US); Patrick J. Leary, Horsham, PA (US); Patrick Wright-Riley, Villanova, PA (US)

(73) Assignee: General Instrument Corporation, Horsham, PA (US)

(21) Appl. No.: 14/202,362

(22) Filed: Mar. 10, 2014

Related U.S. Application Data
(60) Provisional application No. 61/789,404, filed on Mar. 15, 2013.

(51) Int. Cl. G06Q 30/02

(52) U.S. Cl. CPC G06Q 30/0269
USPC 705/14.66

(57) ABSTRACT

Advanced set top devices are beginning to merge with home network gateway devices and will soon become the major single entry point into the home. A growing trend and implementation of home gateways is to provide a centralized data entrance point to end user home. Behavioral information may be compiled from each individual device in the home network, and the home network gateway device determines advertisements to insert specifically to each device based on the entirety of the behavioral information compiled from within the home network. The advertisements provided to individual users within the home network may be determined by the home network gateway device, transparent to entities outside the home network. For example, a headend that delivers content to a home network may not know how many devices are connected to a home network gateway device, the type of devices connected, or which devices are receiving content.

### CROSS-REFERENCE TO RELATED APPLICATION

The present application claims priority from U.S. Provisional Application U.S. patent application Ser. No. 61/789,404 [ATTY DOCKET NUMBER: CS41231-P] filed on Mar. 15, 2013, “Enhancing Targeted Advertising to Multiple Devices Connected to a Home Network Gateway Device,” which is incorporated herein by reference in its entirety.

### BACKGROUND

Traditionally, targeted advertising consists of an advertiser/advertisement scheduler selecting advertisements for individual programs and including the advertisement in the broadcast of the program. The targeting is achieved by matching advertisements with typical characteristics of a typical group of viewers of a specific program. In a television example, cable operators often gather demographic information from various users over a network and associate the information with the programs it provides. The cable operator then selects and inserts advertisements into audio/video content streams to best fit the demographics of the group of viewers. For example, toy advertisements are transmitted during a transmission of a children's program.

A certain level of targeted advertising has been achieved with video/audio services based on a TV viewer's viewing experience and a user account profile. However, targeted advertising based on a broader end user home activity is limited due to the manner in which information is gathered and delivered over a network, such as a cable network for television. Improved methods are desirable for advertising to optimize how information is gathered and how advertisements are distributed.

### BRIEF DESCRIPTION OF THE DRAWINGS

For the purpose of illustrating embodiments described below, there are shown in the drawings example constructions of the embodiments; however, the embodiments are not limited to the specific methods and instrumentalities disclosed. In the drawings:

FIG. 1 depicts an example of a home network that enhances delivery of content to devices locally connected to a home network gateway device;

FIG. 2 depicts an example flow diagram for enhancing delivery of content to devices locally connected to a home network gateway device.

It is noted that while the accompanying FIGS. serve to illustrate embodiments of concepts that include the claimed invention, and explain various principles and advantages of those embodiments, the claimed invention is not limited to the concepts displayed, as additional embodiments would be readily apparent to those of ordinary skill in the art having the benefit of the description herein such that a display of certain concepts are not necessary to understand such embodiments.

### DETAILED DESCRIPTION

Advanced set top devices are beginning to merge with home network gateway devices and will soon become the major single entry point into the home. A growing trend and implementation of home gateways is to provide a centralized data entrance point to end user home. Conventional methods of targeted advertising do not address or support the scenarios present when a home gateway serves a home.

Disclosed herein are techniques for gathering and processing consumer behavior information in a home network gateway device to target users/devices within the home network gateway device. In particular, the concepts disclosed relate to how the information would be used to target ads to devices, referred to herein as home devices, connected to a localized advertisement decision manager (ADM) in a home network or in the home ecosystem. The information may be compiled from each individual device in the home network, and the home network gateway device determines advertisements to insert based on the entirety of the behavioral information compiled from within the home network. As described in more detail below, the advertisements provided to individual users within the home network may be determined by the home network gateway device, transparent to entities outside the home network. For example, a headend that delivers content to a home network may not know how many devices are connected to a home network gateway device, the type of devices connected, or which devices are receiving content.

FIG. 1 depicts an example of a home network that incorporates the disclosed techniques.

The home network shown in FIG. 1 depicts a home network gateway device 120 or media server device (e.g., set top gateway/media streamer) 120 in communication with home devices 101, 102, 103, and 104. The home network gateway device 120 includes memories 105, 106, 107, 108, an algorithm processor 109, advertisement decision manager 110, ad insertion logic 111. The home network may be in communication with destination devices 112, 113, 114, and 115.

A home device 101, 102, 103, and 104 is a device with data processing and data communication possibilities. Examples of a client device include a set-top box, a smartphone, a table computer, a netbook computer, a laptop computer, etc. The client devices 101, 102, 103, and 104 communicate and exchange data with a home network gateway device 120. The example home devices 101, 102, 103, and 104 shown in FIG. 1 include devices capable of transmitting/receiving video 101 (e.g., a set top box), devices capable of transmitting/receiving data 102 (e.g., a personal computer, iPad, mobile device via Wi-Fi), devices capable of transmitting/receiving voice 103 (e.g., a phone, a VOIP application), and mobile devices 104 that may enter and leave the home network, where a mobile device may be accessible by the home network via a Wi-Fi link, GPS location, account information, etc.

In embodiments, the advertisement decision manager 110 is a software module responsible for gathering consumer behavioral information and using that information to determine which targeted ads to deliver when an advertisement opportunity presents itself. The home ecosystem in this manner may perform localized data collection, using the home gateway to monitor content transmitted and received by the home network.

A home network gateway device 120 connects a residential building's local area network (LAN) to a wide area network (WAN) outside the residence. Most home network gateway devices 120 provide broadband connectivity and Internet connection sharing for various home devices. A cable operator or service provider (e.g., Verizon, Comcast) may allow for WAN connections to a multitude of specialized head end servers that reside in the service provider's headend or connected to the internet itself (e.g., YouTube). The service provider's headends may enable delivery of content or services over an infrastructure that is not under the administrative control of the content or service provider (i.e., Over the Top (OTT) content streaming).

The home network gateway device 120 disclosed serves as a central hub for many home devices, including home network devices or mobile devices connecting over the Wi-Fi network. The home devices connected to the home gateway may include client or computing devices, such as set-top boxes, tablets, personal computers, mobile devices, complex event processing devices, gaming systems, or the like. Many complex event processing (CEP) devices can be connected to such home network gateway device 120 and consume data.

The local advertisement decision manager (ADM) 110 associated with a home gateway may gather an assortment of consumer behavior related information from each device connected to the home gateway. Thus, the local ADM 110 collects the information on the consumer behaviors from the devices to which it is connected. In embodiments, the local ADM 110 requests, receives and processes consumer behavioral information from devices that are connected to a centrally located media server device (i.e. set top gateway/media streamer) 120 on the consumer's home network. A set top gateway device, for example, may be a multi-tuner set top gateway device that acts as a home networking hub for all media content that enters the home via a WAN connection. The set top gateway device may deliver content to home devices, such as DTV, tablets, locally connected mobile phones, IP client set tops, and the like.

In embodiments, the ADM 110 sends a message (e.g., a RequestConsumerBehavioralInformation( )) to the home devices. The home devices gather consumer behavioral information from the specific software functions that run on that device. For example, a device that has a browser would send browser based consumer behavioral information and an IP Client Set top box may provide service selection consumer behavioral information. In another example, devices, e.g., mobile devices, may require application supplied from a provider to access content from a gateway. A behavior collection function may be added to the supplied application. In embodiments, the home devices initiate the provision of behavioral information to the ADM 110.

Information gathering can be either by the device (101-104) and sent to 120/109/110, or 120/109/110 can sniff the link to 101-104 and get information by itself.

The types of user behavior that may be collected include set top box (STB) viewing history and behavior, browsing history, e.g., from an iPad, mobile (via WIFI), PC browsing history, IP phone calling history/timing, GPS location info and location history, e.g., from mobile devices, and mobile device availability times (identifying when devices leave and enter the home network. The content from which behavioral information may be identified includes content being watched, content that has been recorded, or content that is scheduled. For voice home devices, for example, the behavior information identified and stored may include call history information. For mobile phone devices, where mobile devices transition from outside the home network to inside the home network, mobile device information can be requested from the home network gateway device 120 while the mobile device is in range of the home network. Since each device is connected to the home gateway, an assumption can be made that the information gathered is specific to the residents and the occupants who live there, providing an advantage over network based ADM 110 data collection/decision making where it is more difficult to make a device/residence connection

The ADM 110 is configured to recognize targeted ad opportunities on streams being sent to the devices for which it has set up consumer behavioral folders. The ADM 110 is able to recognize device connections made to the device on which it resides (i.e. Set Top Gateway/Media Streamer). The ADM 110 may create folders represented by memories 105, 106, 107, 108 for respective devices to store any consumer behavioral information that it will receive in the future for each particular device. The gateway device may include a significant amount of storage since it will be asked to supply media for many different services. The gateway device may also be the central storage repository within the home for content, such as digital video recorded (DVR) content. Further, the gateway device may include an Ad Decision Manager (ADM 110) that would be responsible to target ads to those devices to which it streams content.

The ADM 110 receives responses to messages send to the home devices. For example, in response to a RequestConsumerBehavioralInformation( ) message, the ADM 110 receives responses from those devices connected to the centrally located home network gateway device 120. The ADM 110 receives the information and stores it in the appropriate location, e.g., a device-specific folder.

Various algorithms are available via the algorithm processor 109. The ADM 111 may use various algorithms processed in the algorithm processor 109 to determine which targeted ad to send to devices within the home network. An algorithm could use one or more than one consumer behavioral information to determine which ad to send to a given device. The ADM 110 has the option to choose the best fit ad if multiple ad insertion opportunities exist at a single instance for the various devices and there is limited ad material to choose from or there is a limitation in the bandwidth available to pull in ad material. In embodiments, the algorithm can be used on data delivered to the user to determine, prior to the ad opportunity or in real-time as the opportunity arises.

The home network gateway device 120 has access real-time to compile behavior information from a subset of the home devices to which it communicates via the home network. The home network gateway device 120 has access to identify which devices are requesting or receiving what content from the gateway device at any given time. Based on the compiled behavioral information, and depending on the advertisements that are available, the home network gateway device 120 can more efficiently select advertisements at suitable times and to suitable devices within the home network.

Thus, by using a local advertisement decision manager within a home network gateway device 120, the client side of content delivery controls advertisement selection for individual users within the home network, transparent to entities outside the home network. If a user is receiving content via a home network gateway device 120 providing the single point of entry in to the home for content delivery systems, the content delivery entities only know that content is delivered to the home network, not which devices within the home network are receiving which content. For example, the knowledge that a user watching a channel, e.g., ESPN, via a tablet PC connected using Wi-Fi and linked through the gateway to the network, may be known to the home network gateway device 120, but not to any network outside the home. The home network gateway device 120 thereby learns and compiles the behaviors of the entire home network and can attribute specific behaviors to specific devices linked through the home network gateway device 120. The home network gateway device 120 may receive from the network or store locally advertisements to transmit to the home devices. The home network gateway device 120 may actively communicate with the network and request ads to be received for transmitting by the home network gateway device 120 to the home devices.

Additional examples are now described to illustrate how the components in the home network gateway device 120 may function for targeted advertising.

In an example scenario using the disclosed techniques, consider a mobile device streaming scenario using consumer behavior information of a specific device. A consumer in this example is using a mobile device to browse internet for information on an item, e.g., a car. The consumer uses a mobile phone to request streaming of content via the home network gateway device 120 connection. The ADM 110 requests/receives/processes consumer behavior information via a mobile device consumer behavioral information request. The ADM 110 identifies a network ad opportunity from stream that is being transmitted to same mobile device. The ADM 110 selects a targeted ad for car based on the consumer behavioral information it received from the mobile device.

In another example, consider a mobile device streaming scenario using consumer behavior information gathered from other devices connected to the home network gateway device 120. In this example, a consumer is using a set top gateway to browse internet for vacation information. The consumer uses a mobile phone to request streaming of content via a home network gateway device 120 connection. The ADM 110 requests consumer behavior information from the mobile device but does not receive any. The ADM 110 requests/receives/processes consumer behavior information from Set Top Gateway consumer behavioral information request. The ADM 110 identifies a network ad opportunity from a stream that is being transmitted to same mobile device. The ADM 110 selects targeted ad for vacation based on the consumer behavioral information it got from the Set top gateway. In this example, the information from additional devices connected to the home network may be included because of the type of search, where a vacation usually involves several family members and so information for more users within the household may be relevant.

In another example, consider a smart digital television (DTV) streaming scenario using consumer behavior information gathered from other devices in the home. A first consumer in the home may be using a PC to browse internet for vacation information. A second consumer in the home may be using a mobile phone to browse internet for car information. A third consumer may be using DVT to request streaming of content via a home network gateway device 120 connection. The ADM 110 requests/receives/processes consumer behavior information from a mobile device and gets car based search information. The ADM 110 requests/receives/processes consumer behavior information from PC and gets vacation based search information. The ADM 110 identifies a network ad opportunity from the stream that is being transmitted to DTV, and selects a targeted vacation ad based on the consumer behavioral information it got from the PC. The ADM 110 also identifies a network ad opportunity from the stream that is being transmitted to DTV, and selects a targeted car ad based on the consumer behavioral information it got from the mobile device.

In another example, consider if the advertisement options are a car ad or a restaurant. The home network gateway device 120 determines who is displaying content at a home device in the home network, e.g., which home device is consuming bandwidth at any given time. Based on behavioral data compiled from the various home devices on the home network, the home network gateway device 120 can select the appropriate home device to receive which advertisement. Further, depending on the sophistication of the algorithm processors and advertisements available for insertion/display, the home network gateway device 120 may select a more specific advertisement in the subset of a general category of advertisement. For example, the home network gateway device 120 may determine that a tablet user has selected to view cars and thus the general category of an advertisement for use with the tablet user may be a car advertisement. However, the home network gateway device 120 may identify that the user mostly searches for Ford model cars. Thus, the ad selected for the tablet may be a Ford advertisement available in the general category of car advertisements.”

It is noted that, in accordance with the disclosed techniques, there are opportunities for the content provider to deliver multiple advertisements available for a designated time slot to a home network via the home network gateway device 120. The home network gateway device 120 is the entity responsible to choose the best fit ad to be inserted based on the behavioral information compiled for the entire home network. Further, by keeping track of feedback from specific devices within the home network, the home network gateway device 120 can even more specifically tailor ad delivery to specific devices where there are multiple advertisements available from the network or headend.

Thus, as disclosed, the ADM 110 combines the concept of a consumer behavior information collector function with an element for processing algorithms to filter available ads to provide a single candidate ad or multiple candidate ads for the local ADM 110 in the gateway. The disclosed techniques may be used by an operator or any data service provider to gather useful end user specific data and take actions based on the collected data.

It is also envisioned that the decision algorithms that are used to target ads to a given device or for all devices could use this information that is gathered in a number of different ways. The disclosed techniques define methods of gathering and making optimal use of consumer behavioral information gathered from multiple devices that are used in a consumer's household. This information is used to determine which advertisements to deliver to specific devices when advertisement opportunities occur while delivering network programming to a given device. The targeted advertisement techniques provide enhanced options for advertisers without putting undue cost and traffic on the network.

The Local ADM 110 would gather an assortment of consumer behavior related information from each device. The Local ADM 110, for example, may collect user preferences including geographical information, current channels selected, personal preferences input by the user, commuting information, schools attended, user feature interaction history at the client device, including recorded programs, video and audio library information, ratings for content viewed and rated by the user.

For further segmentation, the local ADM 110 associates behavior data gathered from a connected device in the home with the particular device. It remembers this association even after the device is no longer connected to the Set top gateway. Since the data is collected inside the consumer's home it is advantageous to also process the information gathered from different devices in the home to determine target advertisement opportunities. The Local ADM 110 collects analytics and selects the advertising based on algorithms for determining an advertisement to insert.

The disclosed techniques enable technology within the home, via the home network gateway device 120, to monitor, record, analyze, and respond to consumer content consumption behavior in the form of targeted advertising. As home gateway processing power evolves, so will the complexity available for algorithms for performing targeted ad insertion.

The home network gateway device 120 acts as a conditional access termination point (e.g., from MediaCipher based CA to IPRM-based DRM) and can monitor and analyze content with a goal of collecting client device viewership behavior and statistics for targeted ad delivery. Further, the disclosed concepts utilize local processing and storage, reducing the traffic and processing burden on the network/cloud. And even further, the use of the home network gateway device 120 according to the disclosed techniques may alleviate or eliminate privacy concerns due to the client device/consumer behavior information remaining local to the client device and need not be shared with the network in order for the system to successfully perform targeted ad insertion.

FIG. 2 depicts an example flow diagram for enhancing delivery of content to devices locally connected to a home network gateway device. At 202, media content is received from a content delivery network at a home network gateway device that provides a centralized data entrance point to a home network, the home network comprising a plurality of individual devices in a local network linked to the home network gateway device. At 204, an advertisement decision manager (ADM) compiles behavioral information associated with the plurality of devices in the local network. At 206, the ADM attributes at least one behavior to at least one of the plurality of devices in the home network based on the compiled behavioral information. At 208, the ADM determines which advertisements to insert for the at least one of the plurality of devices in the local network based on the at least one behavior attributed to the respective device.

The home network gateway device learns and compiles the behaviors of the entire home network and can attribute specific behaviors to specific devices linked through the home network gateway device. As described, the client side of content delivery controls advertisement selection for individual users within the home network. The content delivery entity only knows what content is delivered to the home network, but not which devices within the home network are receiving which content.

In embodiments, a headend delivers content to the home network without knowledge of advertisements are distributed to the individual devices on the home network. It is noted that the behaviors attributed to the at least one of the plurality of devices is user-centric, such that a user is associated with more than one device in the home network and the behaviors are attributed to the multiple devices associated with the user. At least one of the plurality of devices is a mobile device, and the ADM compiles information from a mobile device when the mobile device is in range of the home network, wherein the mobile device stores behavioral data that is earned when not in range. The behavioral information compiled and analyzed is based on a real-time consumption of data on the at least one of the plurality of devices, such that the behaviors attributed to the at least one of the plurality of devices is session based. In embodiments, the content delivery network delivers multiple advertisements to the home network gateway, and the home network gateway device is the entity responsible to choose whether to deliver and, if delivering, which advertisement to provide to the at least one of the plurality of devices.

In one or more examples, the functions described herein may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

A computer-readable storage medium may have stored thereon instructions that, when executed, cause a processor to divide the OFDM channel in to a plurality of modulation tiers across the plurality of subcarriers based on a modulation level. Instructions further cause the processor to define a metric associated with a measurable characteristic of the network elements, wherein at least one metric value for the metric is associated with each of the plurality of modulation tiers, and collect measurements for a plurality of the network elements communicating over the OFDM channel, each measurement corresponding to one of the plurality of network elements and a respective one of the plurality of subcarriers. For each of the plurality of network elements, the instructions cause the processor to translate the measurements collected for the respective network element for comparison to the metric values associated with the plurality of tiers, and allocate each of the plurality of network elements to a tier in the plurality of modulation tiers based on the comparison of the measurements collected for the plurality of network elements to the metric values associated with the plurality of modulation tiers.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

We claim:

1. A method for client side control of content delivery through a home network gateway device, the method comprising:
receiving media content from a content delivery network at the home network gateway device that provides a centralized data entrance point to a home network, the home network comprising a plurality of individual devices in a local network linked to the home network gateway device;
compiling, in an advertisement decision manager (ADM) localized within the home network, behavioral information associated with at least one of the plurality of devices in the local network;
attributing, by the advertisement decision manager (ADM) localized within the home network, at least one behavior to at least one of the plurality of devices in the local network based on the compiled behavioral information,
wherein the at least one behavior attributed to at least one of the plurality of devices in the local network is transparent to the content delivery network that delivers media content to the home network; and
determining, by the advertisement decision manager (ADM) localized within the home network, which advertisements to insert for the at least one of the plurality of devices in the local network based on the at least one behavior attributed to the respective device.

2. The method of claim 1, wherein the home network gateway device learns and compiles behaviors for an entire home network and can attribute specific behaviors to specific devices linked through the home network gateway device.

3. The method of claim 1, wherein the client side of content delivery controls advertisement selection for individual devices within the home network.

4. The method of claim 1, wherein a content delivery entity has knowledge of one or more contents delivered to the home network, but does not have knowledge of which advertisements are inserted, into the one or more contents, for the at least one of the plurality of devices within the home network.

5. The method of claim 1, wherein a headend delivers content to the home network without knowledge of how advertisements are distributed to the individual devices on the home network.

6. The method of claim 1, wherein the at least one behavior attributed to the at least one of the plurality of devices is user-centric, such that if a user is associated with more than one device in the home network, the at least one user-centric behavior is attributed to multiple devices associated with the user.

7. The method of claim 1, wherein at least one of the plurality of devices is a mobile device and the advertisement decision manager compiles information from the mobile device when the mobile device is in range of the home network, and the mobile device stores behavioral data that is earned when not in range.

8. The method of claim 1, wherein behavioral information compiled and analyzed is based on a real-time consumption of data on the at least one of the plurality of devices for a period of time, such that the at least one behavior attributed to the at least one of the plurality of devices is session based.

9. The method of claim 1, wherein the content delivery network delivers multiple advertisements to a home network gateway, and the home network gateway device is responsible to determine whether to deliver advertisements to one or more of the devices in the local network, and, if delivering, which advertisement to provide to the at least one of the plurality of devices.

10. A home network gateway device comprising:
at least one input/output port configured to:
communicate with a plurality of data communication devices in a home network, wherein the home network gateway device provides a centralized input point for receiving cable services from a headend, and
in response to a request for behavioral information, receive responses from one or more of the plurality of data communication devices connected to the home network gateway device; and
an advertisement decision manager configured to:
compile consumer behavioral information from the one or more of the plurality of data communication devices in the home network to which the home network gateway device is connected;
store the consumer behavioral information specific to each of the plurality of data communication devices; and
identify targeted ad opportunities on streams being sent through the home network gateway device to the one or more of the plurality of data communication devices.

11. The home network gateway device of claim 10, wherein the home network gateway device has access to identify which of the plurality of data communication devices are requesting or receiving content from the home network gateway device at any given time.

12. The home network gateway device of claim 10, wherein based on the compiled behavioral information, and depending on the advertisements that are available, the home network gateway device selects advertisements at suitable times for the at least one of the plurality of devices within the home network.

13. The home network gateway device of claim 10, wherein the home network gateway device has access real-time to compile behavior information from a subset of home devices to which it communicates via the home network.

14. The home network gateway device of claim 10, wherein the advertisement decision manager is able to recognize device connections made to the home network gateway device on which the advertisement decision manager resides.

15. The home network gateway device of claim 10, wherein the home network gateway device is a central storage repository within the home network for storing content.

16. The home network gateway device of claim 10, wherein the home network gateway device comprising the advertisement decision manager is responsible to target advertisements to the at least one of the plurality of devices to which the home network gateway device streams content.

17. The home network gateway device of claim 10, wherein devices in the home network initiate a provision of behavioral information to the advertisement decision manager.

18. The home network gateway device of claim 10, wherein the home network gateway device serves as a central hub for at least one home device connecting over a Wi-Fi network, wherein the home network gateway device is configured to connect a residential building's local area network (LAN) to a wide area network (WAN) outside a residence.

19. The home network gateway device of claim 10, wherein types of behavioral information that may be compiled includes at least one of a set top box (STB) viewing history and behavior, browsing history, phone call history calling history/timing, GPS location info, location history, and mobile device availability times.

20. The home network gateway device of claim 10, wherein a content from which behavioral information is identified includes at least one of content being watched, content that has been recorded, or content that is scheduled.

21. The home network gateway device of claim 10, wherein the home network gateway device is connectable to a mobile device that transitions from outside the home network to inside the home network, wherein at least one of stored or real-time mobile device information can be requested from the home network gateway device while the mobile device is in range of the home network.

22. The home network gateway device of claim 10, wherein a data communication device is a device capable of at least one of transmitting video, receiving video, transmitting data, receiving data, transmitting voice, or receiving voice.

23. The home network gateway device of claim 10, wherein a data communication device is at least one of a set-top box, a smartphone, a tablet computer, a netbook computer, a laptop computer, a tablet, a personal computer, a mobile device, a complex event processing device, or a gaming system.

24. A computer-readable storage medium having stored thereon instructions that, when executed, cause a processor to:
receive media content from a content delivery network at a home network gateway device that provides a centralized data entrance point to a home network, the home network comprising;
compile behavioral information associated with a plurality of devices in the home network, wherein the home network comprises a plurality of individual devices in a local network linked to the home network gateway device;
attribute at least one behavior to at least one of the plurality of devices in the home network based on the compiled behavioral information,
wherein the at least one behavior attributed to individual devices in the plurality of devices in the home network is transparent to the content delivery network that delivers the media content to the home network;
determine which advertisements to insert for the at least one of the plurality of devices in the local network based on the at least one behavior attributed to the respective device.
